(19) United States
(12) Patent Application Publication
(10) Pub. No.: US 2005/0177396 A1
(43) Pub. Date: Aug. 11, 2005

(54) Method and apparatus for performing concurrent patient coding for hospitals

(76) Inventors: Meir Gottlieb, Baltimore, MD (US); Gabriel L. Weisz, Baltimore, MD (US); Todd Johnson, Parkville, MD (US)

Correspondence Address: GOTTLIEB RACKMAN & REISMAN PC, 270 MADISON AVENUE, 8TH FLOOR, NEW YORK, NY, 100160601, US

(21) Appl. No.: 11/033,062

(22) Filed: Jan. 11, 2005

Related U.S. Application Data
(60) Provisional application No. 60/536,373, filed on Jan. 14, 2004.

(51) Int. Cl. G06F 17/60

(52) U.S. Cl. 705/2

(57) ABSTRACT

A hospital documentation system that allows for the electronic capture of data for patient forms. The electronic forms constitute a medical record for the patient. The record is stored and is available electronically to users throughout the institution, both on site and off site as long as a connection to the institution's network is available. Hospital coders review the documentation concurrent with the patient being within the hospital, and can submit queries to the physician, the results of which are also forms captured electronically within the medical record that may be reviewed by the hospital coders. The medical record is used in addition to other systems by the coders to perform hospital coding on the patient case, and ultimately to generate hospital bills and claims for the patient.

### RELATED APPLICATIONS

This application claims priority to provisional application Ser. No. 60/536,373 filed Jan. 14, 2004 and incorporated herein by reference.

The subject matter of this application is also related to application Ser. No. 10/981,116 filed Nov. 4, 2004 entitled METHOD AND APPARATUS FOR HAND-WRITING RECOGNITION, and incorporated herein by reference.

### BACKGROUND OF THE INVENTION

1. Field of Invention

This invention pertains to a method and system in which patient billing files are generated by coders in a hospital concurrently with the patient record. If required, the coders can request information from the health care providers regarding entries in the patient record.

2. Description of the Prior Art

Hospitals are desperately seeking solutions to their financial troubles. In 2000, the Medicare program paid hospitals 1% less than the cost of treating Medicare patients, leaving 58% of hospitals operating in the red for these cases. This gap between the cost of treating Medicare patients and the reimbursement for treatment is widening each year and is expected to reach $18B by 2005. Industry leaders at leading hospitals suspect that at least 1% of hospitals' inpatient revenue is left ‘on the table’ because of inefficiencies surrounding the hospital inpatient coding process. In a $260B industry (including Medicare and private healthcare insurance providers), this equates to $2.6B of unrealized annual revenue that, with the right business practices in place, could be captured.

Physician documentation drives hospital revenue. Incomplete paper documentation and serial workflows (see FIG. 1) are at the heart of this missed revenue opportunity. Details in the clinical documentation are critical in justifying hospital claims. For instance, if a physician writes ‘Pneumonia’ in the patient's bedside documentation (i.e. ‘daily progress note’) and begins to treat the illness, the hospital can only code Simple Pneumonia. If, however, a physician more accurately documents ‘Pneumonia caused by Staphylococcus aureus’ the hospital can then code for a higher reimbursement. The financial benefit to the hospital for the more accurate and comprehensive documentation in this instance is an additional $7,700. This is only one example of how better physician documentation can help grow the top-line revenues of hospitals.

The fact that the paper documentation can only be in one place at one time is a serious threat to hospital financial performance. Today, the daily progress notes are kept at the bedside for the duration of the patient's stay. Numerous hospital administrative processes including hospital billing and resource utilization rely on information in these progress notes. Because hospitals rely heavily on physician documentation, it is in their best interests to ensure the most accurate and comprehensive documentation possible. Unfortunately, any amendment to clinical documentation after the patient is discharged raises ‘red flags’ for the OIG and is a business practice that is discouraged. Hospitals have long realized that concurrent review of progress notes while the patient is still present in the hospital enables them to better identify incomplete documentation. With this information, the hospital staff can work with physicians to identify and clarify documentation without raising concerns from the OIG.

Because the charts must stay at the bedside, hospital administrative personnel have two options to review the documentation: to work in a distributed fashion on the hospital unit floors and review documentation at the bedside while the patient is still in the hospital, or to review documentation after the patient is discharged. Although many hospitals have attempted to review documentation at the bedside, this approach has historically failed because hospital administration found it too onerous and costly to manage hospital coders distributed throughout the hospital. Hospital coders have to compete for places to sit and work as well as compete for time to review the documentation. When access to the paper documentation is in contention, the physician always wins, forcing the staff members to wait or to repeat this process on a different case.

The most popular approach for hospital administration today is to review documentation post-discharge, and to use any feedback that is gained in the review process to educate healthcare providers so that they may be more accurate the ‘next time’ they see a similar patient. Feedback can come in two ways; first, in clarifying vague clinical documentation (as discussed above in the Pneumonia example) and second in understanding the patients' disease classification. The latter is vital in managing the resources of a hospital.

Hospitals are reimbursed a ‘fixed rate’ for a given patient disease classification regardless of how long the patient is actually present in the hospital. The ability for a hospital to confirm the patient's disease classification while they are still admitted allows the staff to prepare a physician to discharge a patient on the appropriate day. For instance, if a patient is admitted with chest pain, which is later determined to be Congestive Heart Failure, the public and private payors will reimburse the hospital for a five-day stay. If the physician discharges the patient on day six, however, the hospital must absorb both the cost of care for the sixth day and the additional utilization of resources. Shrinking the variance on the length of stay is the core task of any performance improvement or hospital utilization management team. But if the hospital cannot review the documentation until after the patient has been discharged, they cannot predict the appropriate discharge date. Today, this information is used to educate physicians so that ‘next time’ they can be more accurate.

The complexity and volume of cases cause hospital coders to miss vital information that exists in the documentation. Today, coders are typically allotted 13-20 minutes to accurately code a patient stay after the patient is discharged. The contents of the patient record, which are used to code the case, are often unstructured and difficult to interpret efficiently and effectively. As a result, claims are submitted that do not accurately reflect the amount of service rendered to the patient. Thus charges and revenue are missed. Leading hospitals perform exhaustive second-round audits of previously submitted claims in an effort to correct mistakes and reclaim this missed revenue.

### SUMMARY OF THE INVENTION

The present invention pertains to a system that provides an enterprise software application that enables real-time clinical documentation review and remote concurrent coding for hospitals. The invention facilitates increased communication between hospital staff and physicians resulting in more comprehensive and accurate documentation. Tablet PC's or other similar data capture devices are used at the point of care to capture information using an intuitive, easy to use, natural interface. The documentation generated by the capture device is then available immediately across the health enterprise in an electronic format to hospital staff that can review and query physicians for clarifications. This ability to review concurrently and query the physician leads to more accurate documentation prior to patient discharge.

The system effectively aids in the collection of comprehensive documentation and enables hospital coders and utilization management specialists to work in parallel with the physician. The ability to review documentation in parallel and communicate with the physician about patient documentation ensures a comprehensive and accurate medical record resulting in improved hospital claims. Additionally, the system facilitates the dialog between hospital utilization management specialists and the physician regarding patient discharge planning.

Hospital coders benefit because the system allows the simultaneous review of clinical documentation while the patient is still in the hospital—a process commonly referred to as ‘concurrent coding’. The hospital coders can be on site at the hospital, or can be at any remote location that has a connection to the hospital's network. Concurrent coding allows hospital coders to digest the documentation incrementally and properly code the case as the patient receives care. Industry leaders have long understood the value of concurrent coding, but staffing issues have prevented implementation. As a result of using the system, coders code concurrently and can formulate queries to physicians prompting them to qualify vague or incomplete documentation. This communication ensures more accurate documentation and allows the hospitals to submit more accurate claims. Consider our earlier pneumonia example. An example is that if a hospital coder notices that a physician has simply documented ‘Pneumonia’ in the progress note, but does not specify the cause of the pneumonia, the coder can simply query the physician to specify the cause in the physician's next progress note.

Utilization management (UM) teams can be more efficient because the coder can classify the patient early in the stay. For instance, if hospital utilization management personnel acknowledge that a patient should have a four-day length of stay based on the diagnosis classification assigned by the hospital coder, the UM personnel can relay that information to the physician using the system. As a result, the UM team can reduce the variance on the projected and actual lengths of stay, and can take immediate action in cases that could potentially fall outside of the targeted date. Currently, hospitals become aware of patient assignments only after the patients are discharged. Once discharged, hospitals cannot intervene to affect either the discharge date or the supporting documentation.

### BRIEF DESCRIPTION OF THE DRAWINGS

FIG. 1 shows a standard process for generating patient records and bills;

FIG. 2 shows a block diagram of the system constructed in accordance with this invention; and

FIG. 3 shows the process used by the system of FIG. 1 to generate the electronic patient records and corresponding bills using concurrent coding.

### DETAILED DESCRIPTION OF THE INVENTION

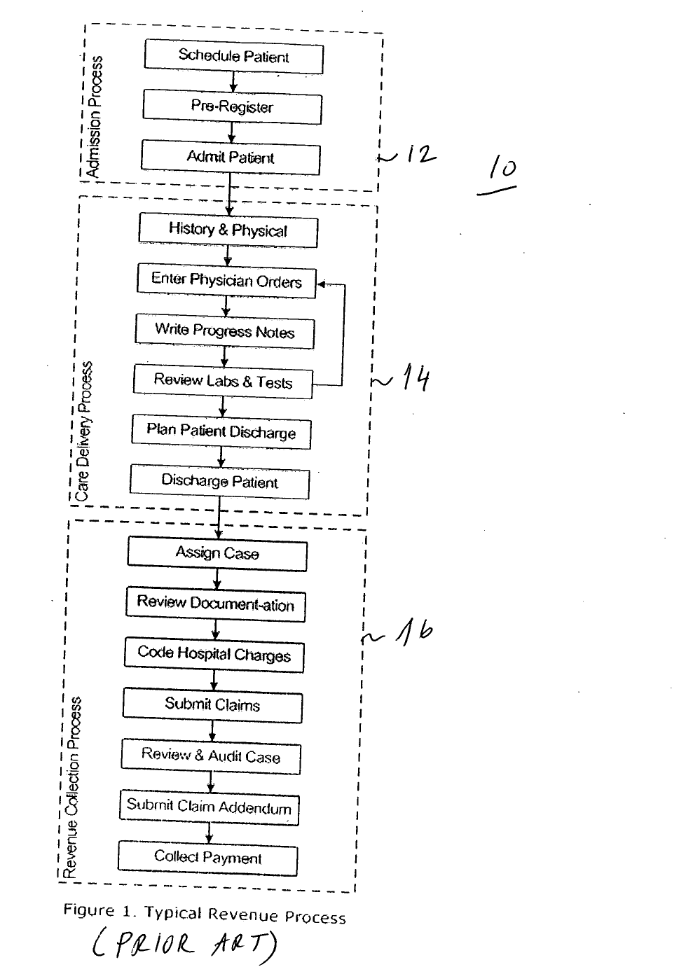

In order to provide a better understanding of the present invention and its advantages over the prior art, a typical billing system in hospital is first described. As illustrated in FIG. 1, such a system consists of three processes: the admission process 12, the care delivery process and the revenue collection process. During the admission process 12 a patient is scheduled for a procedure (and/or observation or other health-related activity), is pre-registered and, then, admitted.

Once admitted, a physical file is made with several forms including a form for the patient's history and physical condition and the physician's orders for the procedure are also entered. This file is commonly known as the patient's chart. Thereafter, every day a physician or other health care provider prepares and enters progress notes. Each progress note is entered on a paper form that becomes part of the chart. Lab results and other tests are also entered placed into the chart.

In addition, plans are also made for the patient's discharge. Finally, if the patient's condition improves, is released.

Importantly, because the patient record has to be maintained and be readily available at the bedside, the billing department does not have access to it until the patient is discharged. Once the patient is discharged, the regulations of various agencies and health care insurance companies require that claims be made promptly. Therefore, during the revenue collection process, the patient's record is assigned to a coder as a case. The coder revues the patient record or documentation quickly and then generates codes for the hospital charges. The codes are then used to generate claims which are submitted for payment.

Since the claims are prepared in a rush, most hospitals have a review policy in place that requires each case to be reviewed at a later time. During the review, each claim and case is reviewed and audited. If necessary an addendum is filed with corrections to the claims.

Finally, the hospital collects payment for the claims.

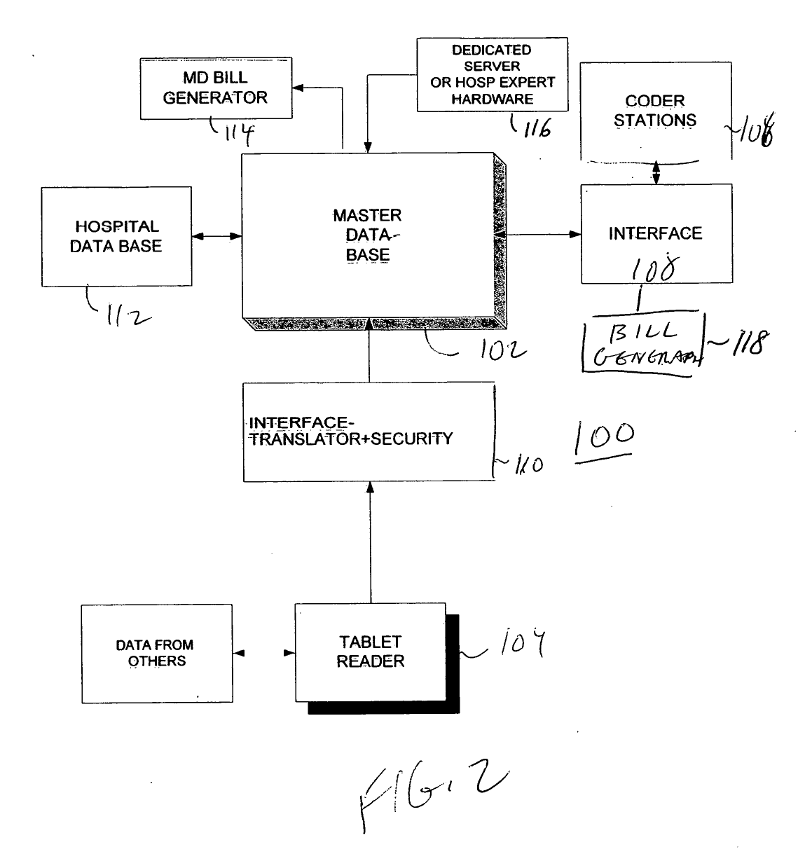

The present application provides a system 100 shown in FIG. 2 that allows hospitals to replace paper documentation with electronic documentation. The system 100 includes a master database 102, a plurality of Tablet PCs 104 or other similar data capture means (one such Tablet PC being shown in FIG. 2) and a plurality of coder stations 106. The Tablet PCs 104 are coupled to the master database 102 by an interface 110 that also provides data translation and security functions. The coder stations 106 are also connected to the master database 102 through an appropriate interface 108. It is important to note that while the coder stations are commonly physically located within the hospital, they in fact can be located anywhere where connectivity to the hospital's network is possible. In addition, the master database 102 is also coupled to the hospital database 112 and receives various information, such as patient information, registration information and insurance information, or other materials, for example, from a dedicated server or hospital expert software 116. The master database 102 can also provide information to the hospital database 112, such as, copies of the documentation generated within the system 100.

The master database 102 also can provide information to an MD bill generator 114 that generates bills covering services provided by doctors. However, for the purposes of this invention, an important function of the system is to generate bills via bill generator 118 based in codes from the coding stations 106.

Briefly, the system 100 operates as follows. A doctor or other service provider enters data on a Tablet PC 104 at a patient's bedside, in a lab, in an OR, or other similar sites. The Tablet PC 104 is coupled through the interface 110 with the rest of the system via a wired or wireless network. The data can also be captured via a desktop computer in a doctor's office, or can be captured by a dictation, transcription, or scanning system.

As each piece of documentation is completed, it becomes available to the coder. In the present invention, the application inserts each form into a master database 102. The coder station 106 determines that new patient documentation is available, and prompts the coder to review the documentation. As more documentation comes in, the coder updates the working code for the patient case, and sends queries to the physician through the system as they arise from the documentation. The physician responds, through the system 100 or by other means, and the responses become part of the patient record, augmenting the original documentation, and are also available to the coder though the system.

Once the patient is discharged, the coder generates a hospital bill that is forwarded to a bill generating agent 118.

Details of the operation and structure of the system shall now be described.

As discussed above, each significant encounter between a patient and a health care provider results in a digital file that is generated on one of the Tablet PCs 104. One or more Tablet PCs are provided in each room, lab, OR, etc. Alternatively, the Tablet PCs are assigned to doctors and health care providers who carry them on their rounds. When the user starts the application, any unsigned queries for that user are displayed in a dialog box. The user can choose to answer the queries at that point, or answer the queries at a later time. If the user chooses to answer a query at that point, then the user is presented with the query form for editing. If the user does not choose to answer a query, then the user is presented with a list of patients. The user selects from the list the patient that he is interested in. The system then displays all the information that is available for the patient and gives the user the option to open a document or create a new form. Users of the system can maintain a list of patients that they see. These lists can be shared or private. When such a user gets on the system, he can choose to select a patient from the hospital population, as described above, or he can select a patient from his own personal list. If a coder has entered a DRG or APR-DRG and assigned an expected length of stay to a patient, then there will be an indication in the list if the patient should be discharged or should have been discharged and was not according to that expected length of stay. The term DRG refers to Diagnostic Related Group and APR-DRG refers to All patient Defined-DRG. DRG pertains to the average cost of the hospital stay of a patient having a specific illness or procedure.

Once the user selects one of the patients, the system displays all the documentation that has been written for the patient to date and gives the user the option of modifying an existing form, or to create a new one. Any incomplete query forms are contained within this list, as are recently completed query forms that the user may wish to review. The user also sees a separate list of unanswered query forms for that patient. If the user chooses to create a new form, he or she is prompted to choose a form template from a list. Forms that have been signed cannot be modified, as they are part of the medical record, but forms that have not been signed can be completed and signed. In some situations form may be started and then signed and completed at a later time. This may happen if a nurse or resident writes the form and the physician reviews and then signs the form at a later time. This may also happen if a piece of important data is not available and the form is left unfinished until the data becomes available.

The form looks and behaves like paper form. The user can write on the form using the stylus. If the user chooses the pen, the application changes the cursor to a small dot representing the tip of the pen. The user writes on the form, and the application shows what the user wrote as if it was ink. If the user chooses the eraser, the application changes the cursor an eraser. The user moves the stylus on the screen and the application erases the ink (the digitally captured handwriting) that is under the stylus. Some styli may have a dedicated eraser built in, which allows for the erasing of data without triggering the eraser mode. A query form will contain data that was put in there by the coder. This type of form will have some data that was entered by the coder, possibly including supporting documentation for the query, and a place for the physician to answer the query and sign the form.

Certain form fields require that the user enter discrete information that the application can then process such as a date or diagnosis. These fields look like a hyperlink and display text such as “Select Date” or “Select Diagnosis.” If the user taps on one of this hyperlink, the application pops up a box requesting information from the user. When selected, these fields trigger a dialog box for the collection of data specific to that field type. The user can also work on the form in a typing mode, which allows the user to type in each data field and quickly move between them to fill it out. The typing mode allows forms to be conveniently completed on a desktop computer, either through the same application that the Tablet PCs use or via a web based application. Some forms require that certain information be entered in designated fields before the form can be signed. For example, most forms have a field designated for the burden of the condition on the patient. The user can choose one of several entries (e.g., minimal, low, minimal or high). The user must make a choice before the form can be signed. Some fields can be linked in the manner in which they are populated. In these cases a set of rules (including AND. OR, NOT operations) is used to validate the form before it can be signed.

After the user or provider generates and signs a form, the form becomes part of the patient record or documentation. Each patient record consists of several forms that have been generated during the patient's stay at the hospital. Once a form is generated, it is immediately available to the facility, including a coder using a coder station to view electronically. Any query forms that have been generated by the coders are displayed to the physician upon entering the system. The physician can complete the query form at that time or can choose to complete the form at the later date. Once the query form has been completed, it becomes part of the medical record and is available to the coders for review and for the generation of new queries if necessary. This feedback mechanism is at the heart of the concurrent coding process and is what allows the coders ensure that the patient documentation is as complete as possible, and allows for the highest possible reimbursement for the hospital.

The coders use a software application whose operation is described as follows. The coder signs into the application, and is presented with a list of patients that have been assigned to that coder for which there is new completed documentation that that coder has not reviewed, including query forms that that coder may have sent. The coder may select a patient and review forms for that patient. The coder may initiate a new query for that patient, which may be sent either to a single physician or to a group of physicians. After selecting the recipient of the query, the coder is presented with a list of query form templates. The coder selects a query form template, and is presented with a blank query form. The processes is similar to the interface that a physician uses to fill out forms: The form appears to be a piece of paper, with certain patient and coder related fields filled out, and the coder can put data into various parts of the form. After filling out as much of the form as is necessary for the query to be sent to the physician, the coder closes the form and it is saved to the central database, where it will be loaded by the physician application and completed by the physician.

In addition to the list of patients assigned to that coder that have new documentation that has not been reviewed by that coder, the coder interface also contains functionality as follows. The coder may keep notes on each patient currently assigned to that coder. The coder can see a list of all patients currently assigned to that coder. A manager may assign patients that have documentation to a coder. A coder can view a query aging report, which contains a list of queries that that coder has sent, but have not been completed by the recipient. Finally, there is a way for a coder to assign or update a DRG or APR-DRG to the patient case, which will result in the application calculating the expected length of stay for that patient. This expected length of stay is visible in the coder application, and the physician application can indicate to the physician if, according to the documentation, the patient has not been discharged on the appropriate day, or if the patient should be discharged that day.

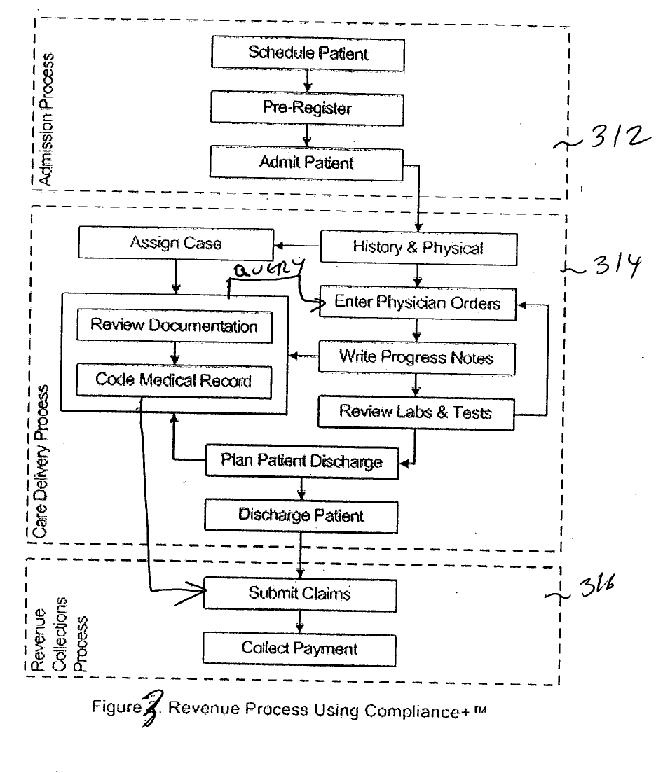

The operation of the system 100 is summarized in the flow chart of FIG. 3. As shown in this Figure, the system still relies on a sequence of steps that define three processes: admission process 312, care delivery process 314 and revenue collection process 316. The admission process 312 is essentially identical to the process 12 in FIG. 1. However the health delivery process 314 is very different. As shown in FIG. 3, this process includes obtaining a history and information from a physical exam and entering the doctor's orders. All this information is entered electronically on the tablet and one or more corresponding forms are generated. Thereafter, additional forms are provided which include progress notes, lab and tests requests and corresponding results. All these forms collectively define the patient record or documentation, as discussed above. However, sometimes after the first form is generated, the patient or case is assigned to a coder, as indicated in the figure. Thereafter, every time that coder accesses the patient record, he can review the status of the patient by looking at the documentation, including all the forms generated by the health care provider, as discussed above. Once he has reviewed the documentation, the coder can start generating code descriptive of the services provided to the patient.

During the daily review of the patient, planning is also started for the patient's release, and this information is also entered on the patient record and can be reviewed by the coder. In this manner, the coder can monitor the progress of the patient and receives advance notice if the discharge is imminent. The coder can also issue queries to physicians, which, once answered, become part of the medical record and are available for further review by the coder.

Finally, the patient is discharged, and by this time, the coder has started, and possibly even completed most, if not all the corresponding coding. The discharge triggers the revenue collections process. As discussed above, during this process, the hospital coding from the coder is released to the bill generator which then generates the claims that are submitted to a government agency, and/or health insurance carrier. Payment is then collected based on the claims.

Of course, if necessary, a review process is also initiated or incorporated into the system so that at regular or random intervals, either some or all the claims are reviewed and audited to determine if a claim addendum is required. However, because of the concurrent coding feature, the likelihood that such an addendum is necessary is greatly reduced.

In summary, the system is used to provide the following functions:
Prepare documentation such as a admission and progress notes, using templates from a master database;
After a form has been published or posted on the master database, allows other personnel, such as coders to send messages (questions) to the provider engaging in a dialog to clarify some aspects of the documentation;
Allows coders to view documentation that has been completed in a structured manor and send queries to physicians, view a list of new documentation for patients assigned to that coder, and view an aging report of queries that have not been answered
Allows the user to augment, annotate, comment on patient documentation previously prepared by others.

As mentioned above, other data entry means may be used instead of the tablet. For example, a form may be filled out in the conventional manner and then scanned by a scanner. Data entry made on a hand-held dedicated or general purpose device such as a PDA. A desktop computer may be used to enter the data. The data can be dictated, transcribed, and imported into the system. Paper forms can be scanned, and the resultant images may be imported into the system. Other smart devices may be used such as a smart pen or smart paper. Moreover, the tablet may be handheld or may be built into the patient bed, table, or other bedside structure. In addition to entering information directly into the Tablet PC, information may also be provided from other sources using a WiFi or other wired or wireless means.

At the coder station, the coder reviews the patient forms, and if appropriate, generates a bill that is then forwarded to the proper organization, and/or the patient. In this manner, the bill is prepared and issued even before the patient leaves the hospital. If changes, or further information is required for the bill, the coder contacts the provider through the tablet or other means and obtains the information fast and efficiently, thereby further insuring that the bill is accurate and completed in a timely fashion. The coder station is on site at the hospital, but can also be a remote location that has access to the hospital network.

Numerous modifications may be made to this invention without departing from its scope as defined in the appended claims.

1. A hospital coding system generating billing claims comprising:
means for inputting patient information to generate a patient specific form;
data collection means for collecting data for patient specific forms and posting the resulting patient forms as digital files; and
coding means obtaining said patient forms and generating hospital coding files, said hospital coding files corresponding to billing claims.

2. The system of claim 1 wherein said means for inputting includes at least an electronic data capture device.

3. The system of claim 1 wherein said inputting means is used to collect information descriptive of a digital form that simulates a paper form.

4. The system of claim 3 wherein said digital file is signed by a user to generate a signed form, said signed form being a read-only form that cannot be altered.

5. The system of claim 1 wherein hospital coding means is adapted to generate a query file to obtain additional information about a patient specific file.

6. A process for generating billing claims in a hospital or other health care provider facility comprising:
generating a digital form for each encounter between a patient and a health care provider;
collating several digital forms associated with a particular patient to form a patient record;
publishing said patient record so that it is available to different personnel, including a coder;
reviewing said patient record by said coder before said patient is discharged; and
generating hospital coding by said coder, said hospital coding defining billing charges for services provided to the patient.

7. The process of claim 6 wherein one digital form is generated by a first user, and wherein said coder generates a query for requesting information from said first user associated with said one digital form.

8. The process of claim 7 wherein said first user generates a response to said coder, said response being associated with said query.

9. The process of claim 8 wherein said coder generates said hospital coding after receiving said response.

10. The process of claim 9 wherein said coder generates a query form with said query, said query form being assigned to at least said first user.

11. The process of claim 7 further comprising generating additional digital forms for said patient record on a regular basis, and wherein said coder is assigned to said patient prior to the generation of at least some of said additional digital forms.

12. The process of claim 7 further comprising converting said patient specific form into a signed form, said signed form being a read-only form.

13. The process of claim 12 wherein said digital form is generated in response to a signature from a user.

14. A process for generating hospital bill charges for services provided to patients comprising the steps:
generating a patient specific set of digital forms for each patient, each set of form defining a patient record;
assigning said patient record to a coder;
generating hospital coding by said coder based on said patient record before the patient is discharged; and
generating billing charges based on said hospital coding.

15. The process of claim 14 wherein a specific digital file is generated by a user, further comprising generating by said coder a question to one of a plurality of users before generating coding corresponding to said specific digital form.

16. The method of claim 15 further comprising generating a digital query form to said user, said query form including said question.

17. The method of claim 16 further comprising presenting said query form automatically to said user the next time said user access the system, collecting an input from said user and storing the query file with the input.

18. The method of claim 17 further comprising presenting said query form with said input to said coder.

19. The method of claim 14 presenting to said coder a list of patient records that include forms that have not been reviewed by any coder.

20. The method of claim 14 further comprising requiring the user to populate fields of the form and to sign the form, the signature being allowed only if at least a required form is populated.
